(19) United States
(12) Patent Application Publication
(10) Pub. No.: US 2011/0132082 A1
(43) Pub. Date: Jun. 9, 2011

(54) MEASURING PROBE FOR OIL AND GAS WELLS AND/OR CASINGS

(75) Inventors: Yamid Pico, Moscow (RU); Masafumi Fukuhara, Moscow (RU); Clement Kostov, Moscow (RU)

(73) Assignee: Schlumberger Technology Corporation, Cambridge, MA (US)

(21) Appl. No.: 12/947,276

(22) Filed: Nov. 16, 2010

(30) Foreign Application Priority Data
Nov. 16, 2009 (RU) 2009141895

(51) Int. Cl. G01N 23/00; E21B 49/00; G01V 3/17; G01V 5/04

(52) U.S. Cl. 73/152.14; 73/152.16; 324/346; 901/2

(57) ABSTRACT

This invention relates to well logging instrumentation, specifically, to measuring devices which use an advanced slip-free borehole contact interaction mechanism. A measuring probe for an oil and gas wells and/or casings includes a main body and at least one robotic arm, fixed to the main body and provided with a polygonal rotating contact tip at the arm's free end. The measuring probe is used as a measuring device and provides a successive slip-free continuous contact between the rotating surface of the tip and the inner wall of the oil & gas wells and/or casings. The tip is furnished with at least one sensor that picks up the geological formations response to a signal emitted directly to the geological formation via the points of contact.

### FIELD OF THE INVENTION

This invention relates to well logging instrumentation, specifically, to measuring devices which use an advanced slip-free borehole contact interaction mechanism.

The new borehole contact interaction configuration allows a tight point-type or linear contact between the moving measuring device, with one sensor or a number of sensors installed thereon, and the inner wall of the oil & gas well borehole and/or casing. The said sensor may be designed as a converter, a receiver, or an integrated converter/receiver.

High-precision robotic arms get in contact with the borehole wall through rotating polygonal or round-shaped tips. Rotating tips decrease surface noise and thus diminish the borehole surface damage. At the contact points, a signal is emitted directly to a geological formation through contact point(s). The response of the formation to the signal is recorded by sensors installed at other (or the same) high-precision robotic arms, or by specially designed sensors, which could be positioned above or below the position, in which a signal is emitted.

The emitted signal may either be a single-component signal, or a complex signal (acoustic, radioactive, electromagnetic, etc.). Acoustic hardware includes ultrasonic, sound, seismic, opto-acoustic and other tools. Since the issue associated with joint assemblies is critical for acoustic measurements, making a direct borehole connection allows the implementation of the following functions: very high energy transmission/receipt efficiency, possibility of vector measurements, minimization of effects associated with a well logging tool movement, measurement of a slow shear without a borehole mode, etc. In situations where the acoustic tools are supplemented with other physical components, e.g., measurements, which require adjustments with the consideration of the neighboring borehole environment, electrode contacts, and point, linear or small sources, etc., this mechanism will bring notable advantages. Furthermore, in situations where polygonal point-type contacts are used, it's possible to use a piezoelectric material in electric pressure (force) sensors as well as optical (opto-acoustic, opto-electronic, etc.) converters.

### BACKGROUND OF THE INVENTION

Well logging tools (U.S. Pat. No. 2,582,314 and U.S. Pat. No. 2,712,627) are used for productive formation characteristic assessment at all stages of well activities (i.e., exploration, preparation, testing, completion and production). Logging requirements are increasingly sophisticated, and there is a necessity to develop this technology and to elaborate new concepts to overcome problems with the assessment of complex characteristics of new productive zones and associated geological formations. These developments focus on logging quality improvement of signal transmission/receipt systems, etc. On the other side, efforts which are taken with the aim of improving the geometry of measurements are insufficient and hardware developments, which are underway now, do not affect the original design of well logging tools.

Russian Patent No. 2319004 discloses a measuring probe for oil and gas wells and/or casings including a main body and a metering device. Measurement errors, lower measurement rates due to a lack of high-precision robotic arms and a narrow field of application (only for defining properties of fluid that flows in oil & gas wells) are the main disadvantages of this measuring probe.

### SUMMARY OF THE INVENTION

It is an object of the invention to develop a measuring probe for oil & gas wells and/or casings, which will provide faster and more accurate logging measurements in boreholes and casings due to high-precision robotic arms with rotating tips of various geometry, which are fixed to the logging tool body and are capable to develop, during the contact of emitters and sensors with a geological formation, such a force which is required for direct measurement of the formation response while the tool goes upward or downward.

This object is achieved by using a measuring probe, which comprises a main body, at least one robotic arm, fixed to the main body and provided with a contact tip at its free end capable to rotate and to ensure a successive continuous contact between the rotating surface of the tip and an inner wall of the oil & gas wells and/or casings while the probe is moving, the contact tip of at least one robotic arm is provided with at least one emitter which emits a signal to a geological formation via a point of contact of the tip and the inner wall of the oil & gas well and/or casing, and at least one sensor located at the contact tip, which picks up the geological formations response to a signal emitted by the emitter.

Furthermore, if a polygon-shaped contact tip is used, a successive contact between the tip surface and the inner wall of oil & gas well and/or casing is provided along the tip vertexes, or if a round-shaped contact tip is used, a successive contact between the tip surface and the inner wall of the oil & gas well and/or casing is provided along the tip circumference.

Furthermore, if two or more robotic arms, at least one emitter that emits the signal to a geological formation via a point of contact of the tip and the inner wall of the oil & gas well and/or casing, and at least one sensor that records the geological formations response to the signal emitted by the emitter, are mounted at the same or different robotic arms.

Furthermore, at least one emitter that emits the signal to the geological formation via the point of contact of the tip and the inner wall of the oil & gas well and/or casing, and at least one sensor that picks up the geological formations response to the signal emitted by the emitter, are mounted at robotic arms fixed to the main body at different heights.

Furthermore, at least one robotic arm is rotatable in the azimuthal direction.

Furthermore, the robotic arm is controlled either by the tip contact force control system, using a spring or suspension system, or by a computer, micro software and/or an operator.

Furthermore, the contact tip is fixed to robotic arm end, or placed inside it, and is capable to rotate by a friction mechanism or by a drive.

Furthermore, the contact tip is made of metal or composite material, or a polymeric matter, or a combination thereof.

Furthermore, the at least one emitter that emits the signal to the geological formation is at the same time a sensor that picks up the geological formations response to the signal.

Furthermore, at least one emitter is an acoustic source, or an electromagnetic emitter or a radioactive source.

Furthermore, the contact tip of at least one robotic arm includes a combination of emitters of different types.

Furthermore, if two or more robotic arms are used, their tips are furnished with different type emitters.

Furthermore, at least one sensor is made of a piezoelectric material.

### DETAILED DESCRIPTION OF THE PREFERRED EMBODIMENTS

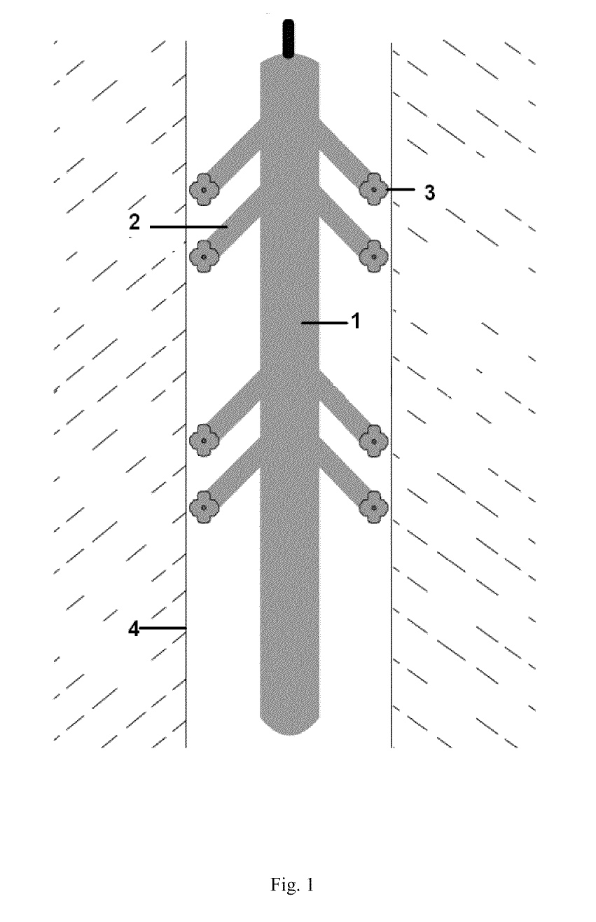

The invention is explained by the drawing. FIG. 1 which illustrates a general view of the measuring probe for oil and gas wells.

This invention relates to measuring probe for oil & gas wells and/or casings, which comprises a main body 1 with at least one robotic arm 2, fixed to the main body 1 and having a contact tip 3, which is provided at its free end and is capable of rotating and to ensure, while the probe is moving, a successive continuous contact between the rotating surface of the tip 3 and the inner wall 4 of the oil & gas wells. The contact tip 3 of at least one robotic arm 2 is furnished with at least one emitter (not shown) which emits a signal to a geological formation via a point of contact of the tip and the inner wall 4 of the oil & gas well borehole and/or casing. The probe comprises at least one sensor (not shown) located at the contact tip, which records the geological formations response to a signal emitted by the source. Furthermore, if a polygon-shaped contact tip is used, a successive contact between the tip surface and the inner wall of the oil & gas well borehole and/or casing is provided along the tip vertexes, or if a round-shaped contact tip is used, a successive contact between the tip surface and the inner wall of the oil & gas well borehole and/or casing is provided along the tip circumference. Furthermore, two or more robotic arms comprise at least one emitter that emits the signal to a geological formation via a point of contact of the tip and the inner wall of the oil & gas well borehole and/or casing, and at least one sensor that records the geological formations response to the signal are mounted at the same or different robotic arms. At least one emitter that emits the signal to the geological formation via a point of contact of the tip and the inner wall of the oil & gas well borehole and/or casing, and at least one sensor that records the geological formations response to a signal are mounted at the robotic arms, which are fixed to the main body at different heights. At least one robotic arm is rotatable in the azimuthal direction. Furthermore, the robotic arm can be controlled either by the tip contact force control system, using a spring or suspension system, or by a computer, micro software and/or an operator. The contact tip is fixed to the end of the robotic arm or inside it, and is capable of rotating by a friction mechanism or by a drive. Furthermore, the contact tip is made of a metal or a composite material, or a polymeric matter, or a combination thereof. Furthermore, the at least one emitter that emits the signal to the geological formation is at the same time the sensor that records the geological formations response to the signal. The at least one emitter can be an acoustic source, electromagnetic emitter or radioactive source. The contact tip of the at least one robotic arm comprises a combination of emitters of different types. If two or more robotic arms, their tips are furnished with the emitters of different types. At least one sensor can be made of piezoelectric material.

The claimed measuring probe is an advanced slip-free borehole contact interaction mechanism. The new borehole contact interaction configuration allows a tight point-type or linear contact between the moving measuring device, with one sensor or a set of sensors installed thereon, and the inner wall of the oil & gas well borehole or casing. The said sensor may function as a converter, a receiver, or an integrated converter/receiver.

The measuring probe for the oil & gas well and/or casing comprises a body that bears the whole measuring system. Single or multiple robotic arms are fixed to the body. The robotic arms are equipped with polygonal or round-shaped rotating tips, which provide the contact between the tips and the inner wall of the oil & gas well borehole and/or casing. While the measuring probe moves along the borehole, the rotating tips turn and ensure a successive slip-free contact between the polygon vertexes and the inner wall of oil & gas well borehole and/or casing. The successive contact is a gradual sequential contact of each point between the tip surface and the inner wall of the oil & gas well borehole and/or casing due to a gradual turn of tip (rotation). A contact force against the inner wall of the oil & gas well borehole and/or casing is controlled by the robotic arm(s). This arrangement ensures a tight point or linear contact. The design of rotating contact tips includes simple, one-component or complex, multiple sensors. The said sensor may function as a converter, a receiver, or an integrated converter/receiver or may be designed as a window(s) for signal transmission/receipt. The sensor includes one or many elements (acoustic, radioactive, electromagnetic and other devices).

Acoustic instrumentation includes ultrasonic, sound, seismic, opto-acoustic and other hardware. Since the issue associated with joint assemblies is critical for acoustic measurements, making a direct borehole connection allows the implementation of the following functions: very high energy transmission/receipt efficiency, possibility of vector measurements, minimization of effects associated with a well logging tool movement, measurement of a slow shear without a borehole mode, etc. If the acoustic tools are supplemented with other physical components, e.g., measurements, which require adjustments with the consideration of the neighboring borehole environment, electrode contacts and point, linear & small sources, etc., this mechanism will bring notable advantages. Furthermore, if polygonal point-type contacts are used, it's possible to use piezoelectric materials in electric pressure (force) transducers as well as optical (opto-acoustic, opto-electronic, etc.) converters.

High-precision robotic arms contact the borehole or casing wall through rotating tips. At the contact points, a signal is emitted directly to a geological formation through the contact point(s). The response of the formation to the signal is recorded by sensors installed at other (or the same) high-precision robotic arms, or by specially designed sensors, which could be positioned above or below the position, in which a signal is emitted.

The use of robotic arms ensures a required contact force and provides control over the position of the sensors against the oil & gas well borehole and/or casing when the measuring probe moves along the borehole upwards and downwards. Such a precise control optimizes the matching of the sensors with aim to improve recording and transmission of signals.

Robotic arms may also be adjusted for an azimuthal rotation. This may be implemented by one or more arms, rotating in the azimuthal direction. Azimuthal rotation for a static position of the measuring probe in a borehole and/or casing may be used for a more detailed scanning of neighboring formation, which may be directly used for anisotropy assessment, strain assessment or other formation properties dependent on the nature of signals used.

For azimuthal rotation, while the measuring probe moves along the borehole and/or casing, robotic arms may start to move spirally, which allows a range of coverage to be extended and the number of robotic arms required for measurements to be decreases. This movement is provided by a combination of the azimuthal rotation of robotic arms and vertical movement of the measuring probe body upwards or downwards in the borehole and/or casing.

A passive, active or combined control system may be implemented. A passive control is provided, e.g., by a passive transducer contact force control system, which is implemented by using a spring or suspension system. Active control hardware may be implemented, e.g., through a system that includes transducers and transducer feedback with the aim of controlling the robotic arms to provide a contact force required for receiving the best measurement conditions. Controls may be implemented through, e.g., a computer, micro-software and/or operator's control as well as programmed sequences. The robotic arm(s) follows the borehole size variances similar to a well caliper, when the measuring probe moves inside the oil/gas well borehole and/or casing prior to or after borehole measurements.

Rotating contact tips are implemented as the end assemblies fixed to mechanical arms, which contact with the borehole and/or casing wells and on which transmitting or receiving sensors are mounted. An example of the rotating contact tip implementation is described at: http://www.slb.com/˜/media/Files/production/brochures/wireline_cased_hole/wirel ine_conveyance/tufftrac_brochure.ashx.

Dependent on the borehole conditions, the rotating tips may have different forms (from round to polygonal) to ensure the best contact during the metering probe movement. The rotating tip material is selected depending on borehole conditions with the aim of ensuring maximum operating flexibility of measurements at acceptable accuracy under different conditions. They may be made of metal, composites, organic/polymeric substances, or a combination thereof. The rotating tips may be fixed at the ends of mechanical arms or inside them, or may use them as supports. Rotation may be arranged by using a friction mechanism or a drive (e.g., motor). This ensures an optimum point/linear contact with a geological formation or casing. Polygonal rotating tips reduce the level of surface noises and decrease the borehole surface damage.

The emitters are the devices, which transmit signals towards the formation, casing and formation/cement boundary via a casing. Sensors are located or used for measuring by the rotating tips. Acoustic, radioactive or electromagnetic emitters may be used. Acoustic instrumentation includes ultrasonic, sound, seismic, opto-acoustic and other hardware. Radioactive tools include chemical sources, radioactive sources, etc. Electromagnetic emitters include current, voltage, induction, opto-electric and other transducers. An example of a sensor which found commercial application is described in Russian Patent No. 2260199. Opto-acoustic sensor design and operating principles are described in I. V. Ostrovsky “Acoustoluminescence, a new phenomenon of acoustooptics”, Soros Educational Journal, No 1, 1998, p. 95-102.

Since the issue associated with joint assemblies is critical for acoustic measurements, making a direct borehole connection allows the implementation of the following functions:
1) Efficient energy transmission/receipt
2) Possibility of vector measurements
3) Minimization of effects associated with a well logging tool movement
4) Measurement of a slow shear without a borehole mode
5) Precise positioning of a transmitter/receiver by depth
6) Elimination of effects associated with a lack of direct connection (acoustic mode variance due to borehole conditions and borehole geometry, head wave, etc.).
7) Very high quality of excitation applied to the geological formation, which brings the best results during signal processing in the interpretation process.
8) Simplified acoustic wave excitation/propagation mechanism. A more simple simulation and prediction of the object's response (e.g., productive formation, casing, cement and a combination thereof).

In situations where acoustic measurements by using an opto-acoustic principle are used, the light (laser) generates thermal contraction & expansion waves, which induce strains in the geological formation. This light is modulated and stress wave frequency is consistent with the modulated light. These waves propagate in the geological formation and may be picked up by receivers located in the instrument body, and another manipulator in whose design the inversion of the opto-acoustic principle was implemented, with the aim of changing the formations optic properties, caused by acoustic waves in the formation (acoustico-optical phenomenon). Since optic signals easily attenuate, if they pass through borehole fluid, the configuration described in the present invention can significantly enhance performance capabilities of the measuring process.

If the acoustic tools are supplemented with other physical components, e.g., measurements, which require adjustments with the consideration of the neighboring borehole environment, electrode contacts and point, linear & small sources, etc., this mechanism will bring notable advantages. Furthermore, it is possible to use piezoelectric materials in electric pressure (force) transducers as well as optical (opto-acoustic, opto-electronic, etc.) converters.

1. A measuring probe for oil and gas wells and/or casings comprising:
a main body,
at least one robotic arm, fixed to the main body and provided at its free end with
a contact tip capable to rotate and to provide a successive continuous contact between a rotating surface of the tip and an inner wall of an oil and gas wells and/or casings while the probe is moving,
at least one emitter disposed at the contact tip to emit a signal to a geological formation via a point of contact of the tip and the inner wall of the oil & gas well and/or casing,
at least one sensor located at the contact tip of at least one arm for recording the geological formations response to a signal emitted by the emitter.

2. The measuring probe of claim 1, wherein the contact tip is polygon-shaped and the successive contact between the tip surface and the inner wall of the oil & gas well and/or casing is provided along the tip vertexes.

3. The measuring probe of claim 1, wherein the contact tip is round-shaped and the successive contact between the tip surface and the inner wall of the oil & gas well and/or casing is provided along the tip circumference.

4. The measuring probe of claim 1, comprising two or more robotic arms, having at least one emitter that emits the signal to the geological formation via a point of contact of the tip and the inner wall of the oil & gas well and/or casing, and at least one sensor that records the geological formations response to the signal mounted on different robotic arms.

5. The measuring probe of claim 4, wherein the at least one emitter that emits the signal to the geological formation via a point of contact of the tip and the inner wall of the oil & gas well and/or casing, and the at least one sensor that picks up the geological formations response to the signal are mounted on robotic arms fixed to the main body at different heights.

6. The measuring probe of claim 1, comprising two or more robotic arms, having at least one emitter that emits the signal to the geological formation via a point of contact of the tip and the inner wall of the oil & gas well and/or casing, and at least one sensor that records the geological formations response to the signal mounted on the same robotic arm.

7. The measuring probe of claim 1, wherein the at least one robotic arm is rotatable in the azimuthal direction.

8. The measuring probe of claim 1, wherein the at least one robotic arm is controlled by a tip contact force control system, using a spring or a suspension system.

9. The measuring probe of claim 1, wherein the at least one robotic arm is controlled by a computer, micro software and/or an operator.

10. The measuring probe of claim 1, wherein the contact tip is fixed to a robotic arm end, or placed inside it.

11. The measuring probe of claim 1, wherein the contact tip is rotatable by a friction mechanism or by a drive.

12. The measuring probe of claim 1, wherein the contact tip is made of a metal or a composite material, or a polymeric matter, or a combination thereof.

13. The measuring probe of claim 1, wherein the at least one emitter that emits the signal to the geological formation at the same time the at least one sensor picks up the geological formations response to the signal.

14. The measuring probe of claim 1, wherein the at least one emitter is an acoustic source.

15. The measuring probe of claim 1, wherein the at least one emitter is an electromagnetic emitter.

16. The measuring probe of claim 1, wherein the at least one emitter is a radioactive source.

17. The measuring probe of claim 1, wherein the contact tip of at least one robotic arm comprises a combination of emitters of different types.

18. The measuring probe of claim 1, comprising two or more robotic arms, having their tips furnished with different type emitters.

19. The measuring probe of claim 1, wherein the at least one sensor is made of a piezoelectric material.
